(19) United States
(12) Patent Application Publication
(10) Pub. No.: US 2009/0189545 A1
(43) Pub. Date: Jul. 30, 2009

(54) ELECTRONIC BALLAST WITH TRANSFORMER INTERFACE

(75) Inventors: William L. Keith, Lake in the Hills, IL (US); George L. Grouev, Arlington Heights, IL (US); Kent E. Crouse, Carpentersville, IL (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Phillips Electronics N..V., Eindhoven (NL)

(21) Appl. No.: 10/597,270

(22) PCT Filed: Jan. 19, 2005
(86) PCT No.: PCT/IB2005/050223

§ 371 Date: Jul. 19, 2006

Related U.S. Application Data
(60) Provisional application No. 60/538,052, filed on Jan. 21, 2004.

(51) Int. Cl. H05B 37/02

(52) U.S. Cl. 315/307

(57) ABSTRACT

An electronic ballast with transformer interface communicating between an external control system and the electronic ballast comprises an outboard circuit (160) operably connected to the external control system and communicating with the external control system by an external signal (140); a transformer (162) being operably connected to the outboard circuit (160) and communicating with the outboard circuit (160) by an outboard signal (166); and an inboard circuit (164) being operably connected to the transformer (162), communicating with the transformer (162) by an inboard signal (168), and communicating with a micro-processor (128) by an internal signal (150). The external signal (140) can use the Digital Addressable Lighting Interface (DALI) protocol. The in board signal (168) can have a lower duty cycle and a higher duty cycle on the primary winding to generate a lower voltage and a higher voltage, respectively, for the outboard signal (166) on the secondary winding.

This invention relates to electronic ballasts for gas discharge lamps, and more particularly, to an electronic ballast with transformer interface.

Gas discharge lamps, such as fluorescent lamps, require a ballast to limit the current to the lamp. Electronic ballasts have become increasingly popular due to their many advantages. Electronic ballasts provide greater efficiency—as much as 15% to 20% over magnetic ballast systems. Electronic ballasts produce less heat, reducing building cooling loads, and operate more quietly, without “hum.” In addition, electronic ballasts offer more design and control flexibility.

Electronic ballasts must operate with different supply voltages, different types of lamps, and different numbers of lamps. Supply voltages vary around the world and may vary in a single location depending on the power grid. Different types of lamps may have the same physical dimensions, so that different types of lamps can be used in a single fixture, yet be different electrically. An electronic ballast may operate with a single lamp, or two or more lamps. The electronic ballast must operate reliably and efficiently under the various conditions.

One particular challenge is to provide an effective, inexpensive interface between external control systems and the electronic ballast. The interface must isolate the electronic ballast from the external control system, while permitting bi-directional communication between the electronic ballast and the external control system. One example of a communication protocol is the Digital Addressable Lighting Interface (DALI) protocol set out in Annex E of the fluorescent ballast standard IEC 60929. The DALI protocol sets interface standards so that ballasts from different manufacturers are useable in a particular lighting system.

The DALI protocol limits the number of electronic ballasts that can be attached to a single external control system bus, i.e., to a single DALI bus. Each electronic ballast draws current from the DALI bus. If too many electronic ballasts are connected to a single DALI bus, the total current drawn by the electronic ballasts drags down the bus and causes communication failure.

Electronic ballasts presently use at least one pair of optocouplers to provide isolation and bi-directional communication. Optocouplers draw a large current, so fewer electronic ballasts can be installed on a single DALI bus. Typically, an optocoupler interface draws 1 to 2 mA, limiting the number of electronic ballasts on the bus to about 64. Optocouplers are also expensive, increasing manufacturing and retail costs.

It would be desirable to have an electronic ballast with transformer interface that would overcome the above disadvantages.

One aspect of the present invention provides an electronic ballast with transformer interface affording isolation with bi-directional communication.

Another aspect of the present invention provides an electronic ballast with transformer interface using little current from the bus.

Another aspect of the present invention provides an electronic ballast with transformer interface allowing more electronic ballasts to be connected to a single bus.

Another aspect of the present invention provides an electronic ballast with transformer interface using a single inexpensive isolation component.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

Various embodiment of the present invention are illustrated by the accompanying figures, wherein:

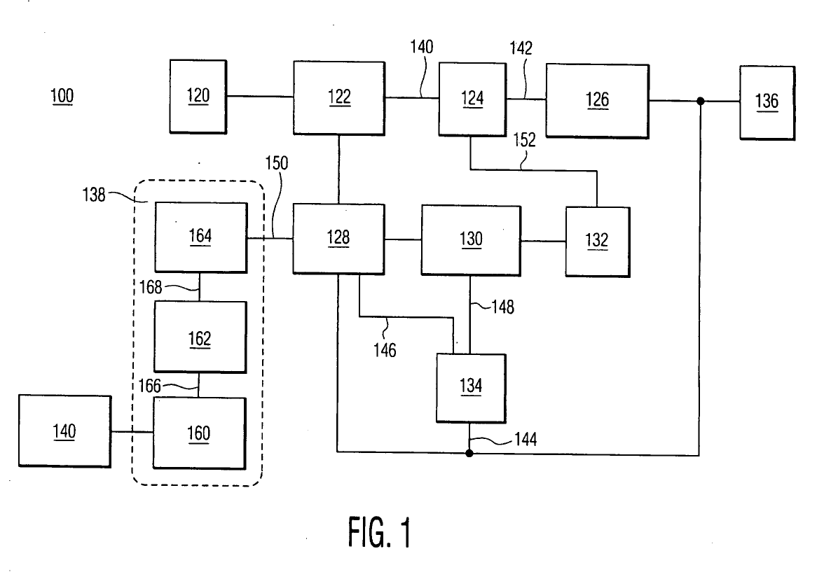

FIG. 1 is a block diagram of an electronic ballast with transformer interface made in accordance with the present invention;

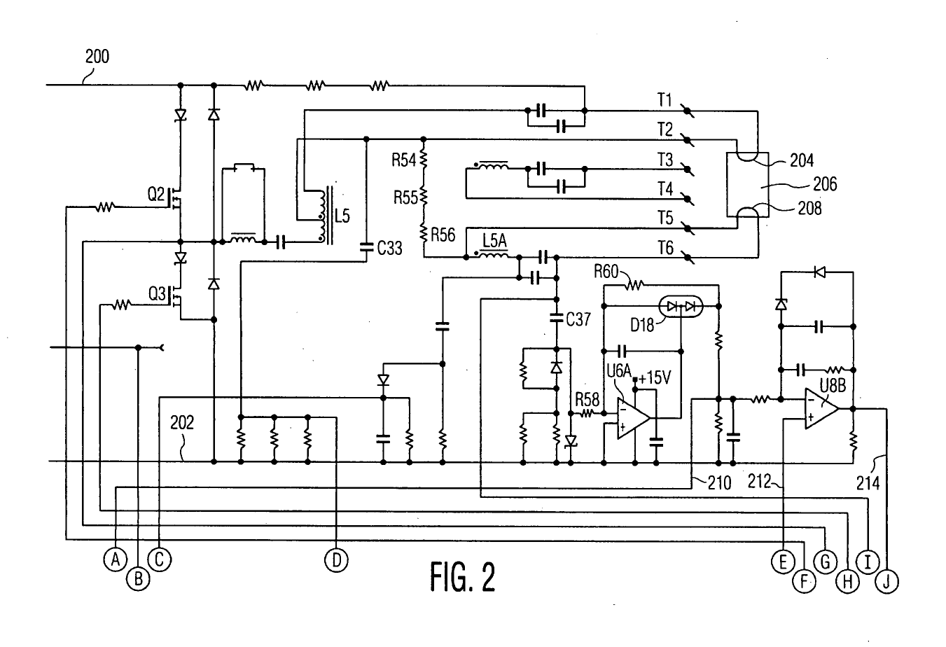

FIGS. 2-4 are schematic diagrams of an electronic ballast with transformer interface made in accordance with the present invention; and

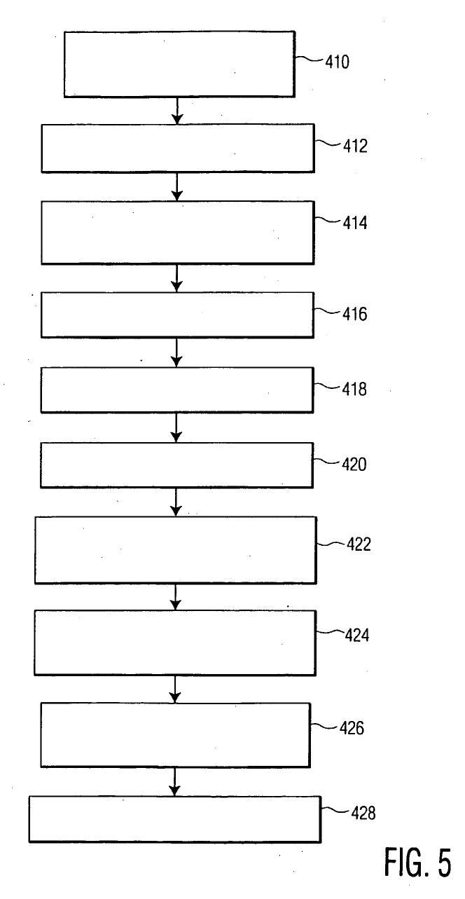

FIG. 5 is a flow chart of a method of communicating between an external control system and an electronic ballast for an electronic ballast made in accordance with the present invention.

FIG. 1 is a block diagram of an electronic ballast with transformer interface made in accordance with the present invention. The electronic ballast 100 consists of AC/DC converter 122, half bridge 124, resonant tank circuit 126, microprocessor 128, regulating pulse width modulator (PWM) 130, high voltage (HV) driver 132, error circuit 134, and a filament current sensing circuit 138. The AC/DC converter 122 receives the mains voltage 120 and the tank circuit 126 provides power to the lamp 136. The communication interface circuit 138 sends and receives external signals 140 to and from external control systems (not shown).

The mains voltage 120 is the AC line voltage supplied to the electronic ballast 100, such as 120V, 127V, 220V, 230V, or 277V. The mains voltage 120 is received at the AC/DC converter 122. The AC/DC converter 122 converts the AC mains voltage 120 to DC voltage 140, which is supplied to the half bridge 124. The AC/DC converter 122 typically includes an EMI filter and a rectifier (not shown). The AC/DC converter 122 can also include a boost circuit to increase the voltage of the DC voltage, such as from 180V to 470V. The half bridge 124 converts the DC voltage 140 to a high frequency AC voltage 142. The resonant tank circuit 126 supplies the AC voltage to the lamp 136. The high frequency AC voltage typically has a frequency in the range of 25 to 60 kHz.

The microprocessor 128 controls the operation of the electronic ballast 100. The microprocessor 128 stores and operates on programmed instructions, and senses parameters from throughout the electronic ballast 100 to determine the desired operating points. For example, the microprocessor 128 sets the AC voltage to different frequencies, depending on whether the lamp is in the preheat, strike, or run mode, or if no lamp is present. The microprocessor 128 can control the power conversion and voltage output from the AC/DC converter 122. The microprocessor 128 can also control the voltage and frequency of the AC voltage from the resonant tank circuit 126, by controlling the frequency and duty cycle of the half bridge 124 through the regulating PWM 130 and the HV driver 132. The error circuit 134 compares sensed lamp current 144 and desired lamp current 146 and provides a lamp current error signal 148 to the regulating PWM 130 for adjustment of lamp current through the regulating PWM 130 and the HV driver 132. The microprocessor 128 communicates with the external control system through the communication interface circuit 138, receiving, storing and acting on instructions and transmitting status information.

The communication interface circuit 138 communicates signals between the electronic ballast and external control system. The communication is bidirectional, so the communication interface circuit 138 can transmit information from the external signal 140 to the microprocessor 128 on the internal signal 150, or can transmit information from the internal signal 150 to the external control system (not shown) on the external signal 140. In one embodiment, the external signal 140 can follow the DALI protocol. Those skilled in the art will appreciate that the communication interface circuit 138 is not limited to use with the DALI protocol and can be used with any binary control protocol in which information is transmitted in a series of high and low bits. The protocol can be structured with start and stop bits, address bytes, and data/command bytes to suit the particular communication desired.

The communication interface circuit 138 consists of an outboard circuit 160, a transformer 162, and an inboard circuit 164. The transformer 162 provides isolation between the external control circuit and the electronic ballast. The outboard circuit 160 is operably connected to communicate with the external control circuit (not shown) by the external signal 140. The transformer 162 is operably connected to communicate with the outboard circuit 160 by the outboard signal 166 and to communicate with the inboard circuit 164 by the inboard signal 168. The inboard circuit 164 is operably connected to communicate with the microprocessor 128 by the internal signal 150. The various signals can be transmitted serially or in parallel, as desired. For example, the internal signal 150 can have one signal path from the inboard circuit 164 to the microprocessor 128 and another signal path from the microprocessor 128 to the inboard circuit 164.

FIGS. 2-4 are schematic diagrams of an electronic ballast with transformer interface made in accordance with the present invention.

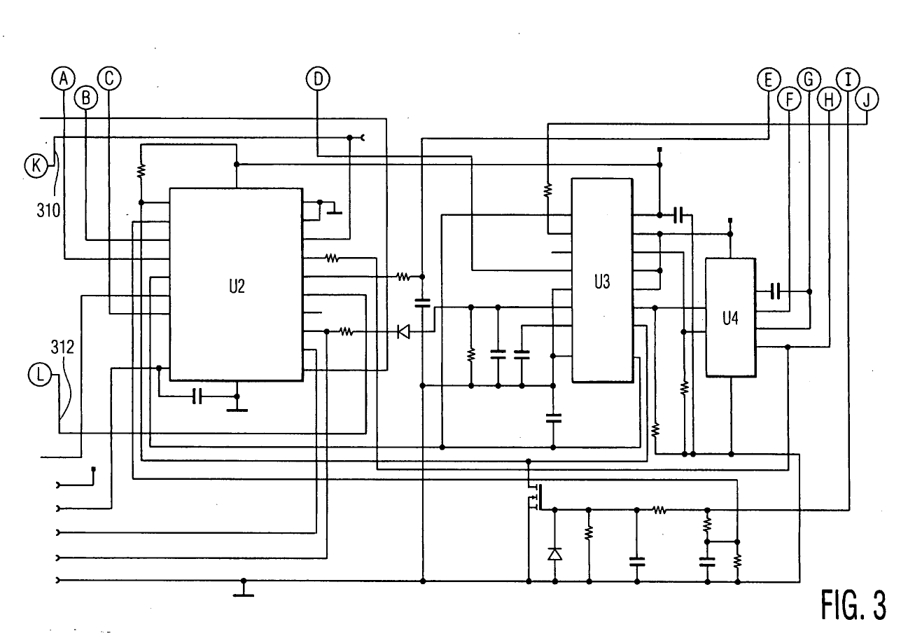

Referring to FIG. 2, DC power is supplied to the resonant half bridge across high voltage rail 200 and common rail 202 by the AC/DC converter (not shown). Transistors Q2 and Q3 are connected in series between high voltage rail 200 and common rail 202 to form a half bridge circuit. The HV driver U4 of FIG. 3 drives the transistors Q2 and Q3 so that they conduct alternately. Inductor L5 and capacitor C33 form the resonant tank circuit and smooth the output at the junction between transistors Q2 and Q3 into a sinusoidal waveform. For use with a single lamp, the first filament 204 of the lamp 206 is connected across terminals T1 and T2 and the second filament 208 is connected across terminals T5 and T6. When two lamps are used with the electronic ballast, one filament from the first lamp is connected across terminals T1 and T2 and the one filament from the second lamp is connected across terminals T5 and T6. The other filaments, one from each lamp, are connected in series or parallel across terminals T3 and T4.

Referring to FIG. 3, the microprocessor U2 is operable to receive inputs from inside and outside the electronic ballast, and to control ballast operation. The microprocessor U2 determines the desired lamp operating frequency and sets the oscillator frequency of the regulating PWM U3, which drives the HV driver U4. The HV driver U4 drives the transistors Q2 and Q3.

The microprocessor U2 receives an incoming signal on line 310 from the communication interface circuit and generates an outgoing signal 312 to the communication interface circuit. The incoming signal on line 310 and the outgoing signal on line 312 provide communication to and from external control systems. In one embodiment, the microprocessor U2 can be an ST7LITE2 available from STMicroelectronics, the regulating PWM U3 can be an LM3524D available from National Semiconductor, and the HV driver U4 can be an L6387 available from STMicroelectronics. Those skilled in the art will appreciate that the particular components other than the exemplary components described can be selected to achieve the desired result. The error circuit senses lamp current at resistor R58 through capacitor C37. Current op amp U8A and high conductance ultra fast diode D18 compose a half wave rectifier with resistors R60 and R58 controlling gain. The sensed lamp current signal is provided to the microprocessor U2 on line 210 and to the error op amp U8B.

The microprocessor U2 generates a desired lamp current signal based on inputs and the desired operating condition and returns the desired lamp current signal to the error op amp U8B along line 212. The error op amp U8B compares the sensed lamp current signal and the desired lamp current signal to generate a lamp current error signal on line 214, which provides the lamp current error signal to the regulating PWM U3. In response to the lamp current error signal, the regulating PWM U3 adjusts output pulse width, which adjusts the lamp current by the cycling of the transistors Q2 and Q3 with the HV driver U4. When the sensed lamp current signal equals the desired lamp current signal at the error op amp U8B, the lamp current error signal will zero out and the electronic ballast will be in a steady state mode.

The electronic ballast operates in preheat, strike, and run modes. The preheat mode provides a preheat sequence to the lamp filaments to induce thermionic emission and provide an electrical path through the lamp. The strike mode applies a high voltage to ignite the lamp. The run mode controls the current through the lamp after ignition.

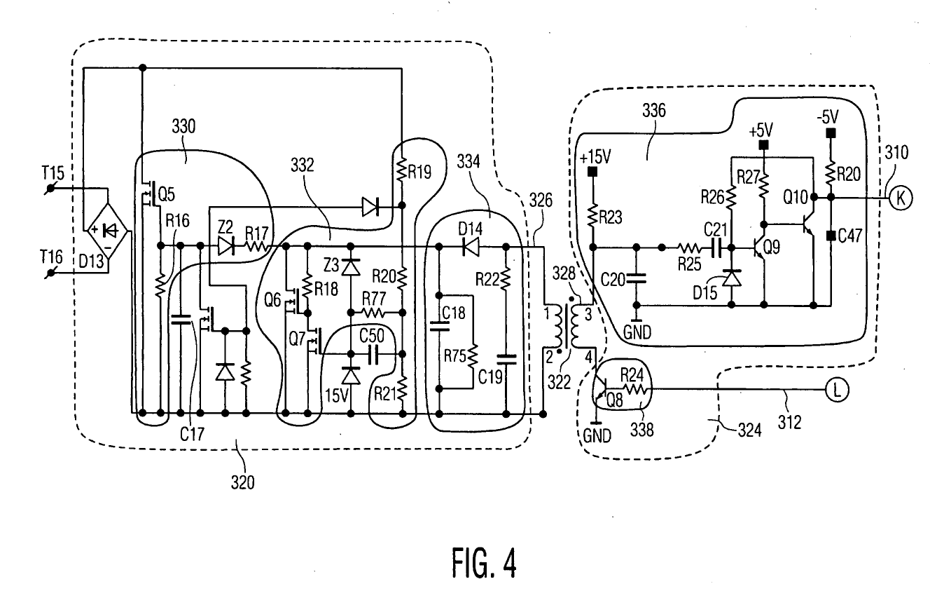

FIG. 4 shows the communication interface circuit of an electronic ballast with transformer interface. The communication interface circuit consists of an outboard circuit 320, a transformer 322, and an inboard circuit 324. The outboard circuit 320 is operably connected to communicate with an external control circuit at terminals T15 and T16. The inboard circuit 324 is operably connected to communicate with the microprocessor U2 (FIG. 3) by the incoming signal on line 310 and the outgoing signal on line 312. The transformer 322 provides isolation between the external control circuit and the electronic ballast. The transformer 322 is operably connected to communicate with the outboard circuit 320 by the outboard signal on line 326 and to communicate with the inboard circuit 324 by the inboard signal on line 328.

The outboard circuit 320 consists of a bridge D13, a send circuit 330, a receive circuit 332, and a rectifier/filter 334. The send circuit 330 includes transistor Q5, resistor R16, Zener diode Z2, and resistor R17. The receive circuit 332 includes transistors Q6 and Q7, resistor R18, ZenerdiodeZ3, and resistors R17, R19, R20, and R21. The rectifier/filter 334 includes capacitor C18, resistor R75, diode D14, resistor R22, and capacitor C19. The bridge D13 communicates between the external control system and the outboard circuit 320 by means of the external signal. The bridge D13 assures proper signal polarity for the communication interface circuit regardless of the polarity of the external control system at terminal T15 and T16.

The inboard circuit 324 consists of an AC coupled comparator 336 and an outgoing switch 338. The comparator 336 includes resistor R23, capacitor C20, resistor R25, capacitor C21, resistor R26, diode D15, transistor Q9, resistor R27, transistor Q10, resistor R20, and capacitor C47. The outgoing switch 338 includes transistor Q8 and resistor R24.

The transformer 322 is connected between the outboard circuit 320 and inboard circuit 324, providing isolation between the external control circuit and the electronic ballast. The secondary winding of the transformer 322 is connected across the rectifier/filter 334 providing the outboard signal on line 326. The primary winding of the transformer 322 is connected in series between the resister R23 of the comparator 336 and the Q8 of the outgoing switch 338.

During operation, the communication interface circuit can be in a wait state, a system receive state, or a system send state. In the wait state, no signals are being sent or received through the communication interface circuit. In the system receive state, signals from the electronic ballast are transmitted to the external control system. In the system send state, signals from the external control system are transmitted to the electronic ballast.

During the wait state, the microprocessor U2 provides a driving signal on line 312 at a lower duty cycle. The driving signal switches the transistor Q8 of the outgoing switch 338. At the lower duty cycle, the current through the primary winding of the transformer 322 produces a lower voltage on the secondary winding at line 326. In one embodiment, the lower duty cycle is about 33% and the lower voltage is about 2.5 to 3.5 volts across C18. The external signal from the external control circuit across terminals T15 and T16 is high, holding line 340 high, which turns on transistor Q7 of the receive circuit 332 through resistors R19, R20, and R17. In one embodiment, the voltage on line 340 is about 16 volts as supplied according to the DALI protocol. This grounds the gate of transistor Q6, so that transistor Q6 is off. The lower voltage across C18 is below the breakdown voltage of Zener diode Z2 of the send circuit 330, so the gate of transistor Q5 is grounded through resistor R16 and transistor Q5 is off.

During the system send state, the external signal from the external control circuit across terminals T15 and T16 changes from high in the wait state to low. Line 340 goes low, turning off transistor Q7 of the receive circuit 332 through resistors R19, R20, and R17. This provides voltage on the gate of transistor Q6 through resistor R18, so that transistor Q6 is on, shorting across the secondary winding of the transformer 322. The short is reflected across the transformer 322 to the primary winding and the comparator 336. The comparator 336 has a large amount of hysterisis and squares up the signal from the primary winding at resistor R25 into an incoming signal on line 310 that is useable by the microprocessor U2. The external signal from the external control circuit across terminals T15 and T16 alternates between high and low conditions to provide high and low pulses to the microprocessor U2.

During the system receive state, the outgoing signal on line 312 switches from the lower duty cycle to a higher duty cycle under control of the microprocessor U2. Transistor Q8 of the outgoing switch 338 switches the current across the primary winding of the transformer 322, which changes the current on the secondary side to change the voltage across C18 from a lower voltage to a higher voltage. The higher voltage across C18 exceeds the breakdown voltage of Zener diode Z2 in the send circuit 330 applying voltage to the gate of transistor Q5, turning on transistor Q5. This voltage also exceeds the breakdown voltage of Zener diode Z3 turning on Q7 and turning off Q6. In one embodiment, the lower duty cycle of about 33% produces a lower voltage of about 2.5 to 3.5 volts, the higher duty cycle of about 66% produces a higher voltage of about 7 to 8 volts, and the breakdown voltage of each Zener diode Z2 and Z3 is about 6.2 volts.

Transistor Q5 shorts across the bridge D13, which shorts across terminals T15 and T16 connected to the external control system. Because the external control system holds a voltage across terminals T15 and T16 in the wait state, the external control system detects the short by the voltage change. The outgoing signal on line 312 from the microprocessor U2 alternates between the lower and higher duty cycle to provide high and low pulses to the external control circuit across terminals T15 and T16. Those skilled in the art will appreciate that the absolute values of the higher and lower duty cycles and higher and lower voltages are not important, only that the higher and lower voltages bound the breakdown voltage of Zener diode Z2 so that the transistor Q5 can be toggled on and off, shorting across the connection to the external control system.

Those skilled in the art will appreciate that a number of different circuits and components can be used for the inboard and outboard circuits to communicate between an electronic ballast and a external control system across an isolating transformer. The circuits are not limited to the examples presented above.

FIG. 5 is a flow chart of a method of communicating between an external control system and an electronic ballast for an electronic ballast made in accordance with the present invention.

An external signal is received from the external control system at 410 and an outboard signal generated in response to the external signal at 412. The outboard signal is transmitted across a transformer to generate an inboard signal at 414 and an internal signal generated in response to the inboard signal at 416. At 418, the internal signal is utilized in a microprocessor. The method ends at 418 if the there is no need for the microprocessor to reply to the external signal.

When the microprocessor needs to send a signal to the external control system, such as in reply to the external signal, a second internal signal is received from the microprocessor at 420 and a second inboard signal generated in response to the second internal signal at 422. The second inboard signal is transmitted across the transformer to generate a second outboard signal at 424 and a second external signal generated in response to the second outboard signal at 426. At 428, the second external signal is transmitted to the external control system.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of communicating between an external control system and an electronic ballast comprising:
receiving an external signal from the external control system 410;
generating an outboard signal in response to the external signal 412;
transmitting the outboard signal across a transformer to generate an inboard signal 414;
generating an internal signal in response to the inboard signal 416; and
utilizing the internal signal in a microprocessor 418.

2. The method of claim 1 wherein the generating an outboard signal in response to the external signal comprises shorting across a secondary winding of the transformer.

3. The method of claim 1 wherein the generating an internal signal in response to the inboard signal comprises:
monitoring the inboard signal on a primary winding of the transformer, and
squaring up the inboard signal.

4. The method of claim 1 further comprising:
receiving a second internal signal from the microprocessor 420;
generating a second inboard signal in response to the second internal signal 422;
transmitting the second inboard signal across the transformer to generate a second outboard signal 424;
generating a second external signal in response to the second outboard signal 426; and
transmitting the second external signal to the external control system 428.

5. The method of claim 4 wherein the second internal signal has a higher duty cycle and a lower duty cycle, and the generating a second inboard signal in response to the second internal signal comprises toggling the second internal signal between the higher duty cycle and the lower duty cycle at a primary winding of the transformer.

6. The method of claim 5 wherein the second outboard signal has a higher voltage corresponding to the higher duty cycle and a lower voltage corresponding to the lower duty cycle.

7. The method of claim 6 wherein the generating a second external signal in response to the second outboard signal comprises shorting across a connection to the external control system in response to the higher voltage.

8. A system communicating between an external control system and an electronic ballast comprising:
means for receiving an external signal from the external control system;
means for generating an outboard signal in response to the external signal;
means for transmitting the outboard signal across a transformer to generate an inboard signal;
means for generating an internal signal in response to the inboard signal; and
means for utilizing the internal signal in a microprocessor.

9. The system of claim 8 wherein the means for generating an outboard signal in response to the external signal comprises means for shorting across a secondary winding of the transformer.

10. The system of claim 8 wherein the means for generating an internal signal in response to the inboard signal comprises:
means for monitoring the inboard signal on a primary winding of the transformer; and
means for squaring up the inboard signal.

11. The system of claim 8 further comprising:
means for receiving a second internal signal from the microprocessor;
means for generating a second inboard signal in response to the second internal signal;
means for transmitting the second inboard signal across the transformer to generate a second outboard signal;
means for generating a second external signal in response to the second outboard signal; and
means for transmitting the second external signal to the external control system.

12. The system of claim 11 wherein the second internal signal has a higher duty cycle and a lower duty cycle, and the means for generating a second inboard signal in response to the second internal signal comprises means for toggling the second internal signal between the higher duty cycle and the lower duty cycle at a primary winding of the transformer.

13. The system of claim 12 wherein the second outboard signal has a higher voltage corresponding to the higher duty cycle and a lower voltage corresponding to the lower duty cycle.

14. The system of claim 13 wherein the means for generating a second external signal in response to the second outboard signal comprises means for shorting across a connection to the external control system in response to the higher voltage.

15. An electronic ballast with transformer interface communicating between an external control system and the electronic ballast comprising:
an outboard circuit 160, the outboard circuit 160 being operably connected to the external control system and communicating with the external control system by an external signal 140;
a transformer 162, the transformer 162 being operably connected to the outboard circuit 160 and communicating with the outboard circuit 160 by an outboard signal 166; and
an inboard circuit 164, the inboard circuit 164 being operably connected to the transformer 162, communicating with the transformer 162 by an inboard signal 168, and communicating with a microprocessor 128 by an internal signal 150.

16. The circuit of claim 15 wherein:
the transformer 162 comprises a primary winding and a secondary winding;
the inboard signal 168 has a lower duty cycle and a higher duty cycle;
the lower duty cycle on the primary winding generates a lower voltage for the outboard signal 166 on the secondary winding; and
the higher duty cycle on the primary winding generates a higher voltage for the outboard signal 166 on the secondary winding.

17. The circuit of claim 15 wherein the external signal 140 follows the Digital Addressable Lighting Interface (DALI) protocol.

18. The circuit of claim 15 wherein the outboard circuit 160 comprises:
a send circuit 330 providing the external signal 140 to the external control system; and
a receive circuit 332 receiving the external signal 140 from the external control system.

19. The circuit of claim 18 wherein the outboard signal 166 has a first state and a second state, and the send circuit 330 is responsive to the outboard signal 166 to short a connection to the external control system when the outboard signal 166 is in the first state.

20. The circuit of claim 18 wherein external signal 140 has a first state and a second state, and the receive circuit 332 is responsive to the external signal 140 to short a secondary winding of the transformer 162 when the external signal 140 is in the first state.

21. The circuit of claim 18 wherein the outboard circuit 160 further comprises:
a bridge D13 operably connected to communicate the external signal 140 with the send circuit 330; and
a rectifier/filter 334 operably connected to communicate the outboard signal 166 with the receive circuit 332.

22. The circuit of claim 15 wherein the inboard circuit 164 comprises:
a comparator 336 providing the internal signal 150 to the microprocessor 128; and
an outgoing switch 338 receiving the internal signal 150 from the microprocessor 128.
